(19) United States
(12) Patent Application Publication
(10) Pub. No.: US 2003/0116725 A1
(43) Pub. Date: Jun. 26, 2003

(54) Web detection with gradient-indexed optics

(75) Inventors: John Herman Sorebo, Appleton, WI (US); Robert Donald Lorenz, Madison, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/027,266

(22) Filed: Dec. 21, 2001

(51) Int. Cl. G01V 8/00; G01N 21/86

(52) U.S. Cl. 250/559.36

(57) ABSTRACT

A device for detecting a web, the device including a light source adapted to emit light generally in the direction of the web; a lens spaced apart from the light source and adapted to receive light originating from the light source, the lens having a radial index of refraction gradient; and an image sensor aligned with the lens, the image sensor adapted to receive light from the lens and to convert the light to a signal. Also, a method for detecting a web, the method including emitting light from a light source; capturing light reflected by the web with a lens having a radial index of refraction gradient; focusing the captured light on an image sensor; and converting the focused light to a signal. Also, a method for aligning two webs, wherein each web has a position, and a method for detecting an object.

### BACKGROUND OF THE INVENTION

The present invention relates to detecting qualities related to a moving web of material. These qualities may also be related to an object attached to or residing on the moving web. The invention particularly concerns detecting qualities related to a moving web of material using gradient-indexed optics. The invention also concerns an improvement in quality detection of a web of material of varying opacity.

A web is a flexible piece of material in which the width and thickness dimensions are significantly smaller than the length. Diverse webs are used pervasively in manufacturing processes around the world. They are used to produce products very efficiently and in high volumes and can be found in the manufacturing processes for such products as tissue, sheet metal, and films. To achieve high efficiencies and volumes, machines convey webs at high speeds, ensuring that they are aligned in the lateral direction so as not to cause processing issues. Examples of problems caused by improper alignment include slitting a product to the wrong width, spraying adhesive off the edges of the web, or failing to make a product to its targeted dimensions. It is often necessary to laminate multiple webs together, yielding a composite web. In this case, it is crucial to ensure that the webs are aligned to within the product specifications, which may require active edge position control. In other cases, discrete objects may be attached to the web or may reside on the web. The alignment and other qualities of these objects must be tightly controlled for maximum manufacturing efficiency.

To actively control the alignment of a web and any objects thereon, certain qualities of the web and/or objects need to be detected. These qualities include the position of the edge of the web, defects in the moving web of material, positioning of one web relative to another, and the positioning, shape, alignment, doneness, or coverage of the web itself or of objects on the web.

As an example, to actively control web alignment, it is first necessary to know where the edges of the web are located relative to a fixed reference point before a controller can cause the actuation of a device to steer or change the width or lateral position of the web. Web edge detection is common with composite webs comprised of multiple webs laminated together. Both web edges are often used as feedback for the web control. Several forms of web edge detection are in commercial use. The dominant types use either a single photodetector or a linear photodetector array.

In single photodetector edge sensing, the edge sensors that are most often used in industry are based on transmitting infrared light from light-emitting diodes (LEDs) across an open air gap that is partially obstructed by the web edge in question. On the other side of the web from the transmitter is a single photodetector, which receives the light and produces a number of electron-hole pairs in the semiconductor proportional to the intensity of the light it has received within the wavelength band to which the semiconductor is responsive.

The electron-hole pairs form an electrical potential that is read by the photodetector interface circuitry as an analog voltage. The analog voltage is sampled and sent to a current or voltage output driver circuit. This signal is then read and used by the web control processor. The output level, be it in the form of a current or a voltage, is a nonlinear function of the lateral position of the web, the material opacity or optical transmittance of the web, and any other spatial properties that could modulate the light energy impinging on the photodetector.

In linear photodetector array edge sensing with spherical lenses, linescan detector array technology, or linear arrays of photodetectors illuminated with a line of light, has been used successfully in determining the location of web edges for nonwovens. A linescan detector array uses multiple, smaller photodetectors or pixels arranged in a line. This effectively samples the light intensity distribution in a direction orthogonal to the edge of the web. The resulting sampled image then can be processed by image processing techniques to extract an estimate of the edge that is generally less sensitive to opacity variations of the web.

The conventional web guiding system is comprised of a sensor for determining web edge position, a signal processor, and an electromechanical guide mechanism for actuation of the web's lateral location. A previous attempt at an automatic lateral control system uses a set of ink marks on a web as its position feedback. One of the marks is slanted at a 45° angle with respect to the other mark. As the web moves laterally, the machine direction difference between the slanted mark and the straight mark will change. A photodetector sees the mark at a different position relative to an encoder position and the control system adjusts a roller to align the web back to where the original difference can be maintained.

Another attempt at web edge measurement uses a binocular measurement system, which operates on a similar principle as a conventional web edge sensor, whereby the detector captures an average light level and transduces that light level into an output proportional to the lateral position of the web or object. In this case, there is one transmitter array of LEDs and two different receiver stations, hence the term binocular.

Yet another attempt at web edge measurement is a carpet position sensor comprised of infrared LEDs as the light source and phototransistors as the light receiver. The light level profile across the carpet web is discretized based on the number of phototransistors and the linear distance of the detection.

Yet another attempt at web edge measurement uses a linescan sensor for web control. Cross correlation at the pixel level is used in part as the signal processing means of further defining the location of the edge of the web. A standard camera-style implementation enables light to be focused appropriately onto the linescan pixels. This system measures the amount of reflected infrared light that is received in a charge-coupled device (CCD) array. The light source transmits light through a beamsplitter and a spherical lens and either gets partially absorbed by the web or gets reflected back to the receiving CCD array by means of a reflector placed on the opposite side of the web from the light source. The sensor then uses the light level transition from reflected light to absorbed light as its basis for edge determination.

Yet another attempt at web edge measurement uses linescan technology in a system configurable to operate on one or up to four different edges with up to two cameras. With this feature of allowing multiple edges to be located, web width measurements could be made and guiding corrections could be based on the midpoint of the two edges detected by the camera system (i.e. the middle of the web) by using only one camera.

Yet another attempt at web edge measurement uses linescan technology in a form factor similar to previous average light level types of sensors. In this design, laser light is emitted and collimated from the emitter side of the sensor. The observed web obstructs a portion of the collimated beams. The receiver on the opposite side of the web from the emitter receives the collimated light that is not obstructed by the web. The receiver device is a linear complementary metal-oxide semiconductor (CMOS) image array that detects for the light level transition.

### SUMMARY OF THE INVENTION

Most linescan detector arrays are designed in a camera-style format where a spherical and/or cylindrical lens system functions to collect light and focus it on the linescan detector array. Although camera-style implementations of linescan detector arrays allow for off-the-shelf application, they do have limitations. One of the limitations of the implementation is the focal distance required. Linescan detector arrays would have further employment if they could be placed in a very confined area where distances from objects to the linescan array are only on the order of inches, not of feet as in the case of a standard 35 mm spherical lens system. Another limitation of the camera-style detector arrays is in the establishment of field of views and its impact on pixel length calibration, i.e. pixel resolution. As the field of view object distance requirement increases, the suitability of the spherical lens for this application decreases. Also, as the field of view increases, the size of the lens and its spherical aberrations increase. Previous systems are limited in use to webs whose edges do not vary in lateral position by more than 5 mm.

There is often a tradeoff between getting sufficient pixel resolution by zooming in versus having sufficient field of view. Zooming to improve pixel resolution also means that absolute pixel resolution is not clearly defined and thus additional calibration methods must be developed. In addition, cross correlations performed in an attempt to improve pixel resolution have not been performed at a sub-pixel level. Previous attempts that employ a system of marks can only work if marks can be placed on the web, and if the mark placement is accurate.

Previous attempts are also limited in their abilities to accommodate materials with varying opacities. While the lack of significant machine-direction spatial variations in material opacity can be a good assumption for some materials like stationary paper, for example, it is not a good assumption for all web materials. Many nonwovens, which are becoming more prevalent in the consumer nondurable and medical products industries, do not typically fit into this category. Nonwovens are materials made from extruded polymer fibers blown onto a moving conveyor where they quickly solidify to form a web. Because these materials are made from polymers, they can be made stronger than more traditional webs, like tissue, at a given basis weight. The problem is that many nonwovens are formed as very thin webs with inconsistent fiber patterns. The amount of light blocked by many nonwovens, particularly spunbonded materials, is consequently inconsistent. To better sense the location of the nonwoven web edge or other qualities of a web or of objects on the web, a more sophisticated sensing methodology is therefore required.

In response to the difficulties and problems discussed above, a new web detection system including improved detection of non-opaque webs and a compact design has been discovered. The purposes and advantages of the present invention will be set forth in and apparent from the description that follows, as well as will be learned by practice of the invention. Additional advantages of the invention will be realized and attained by the containers particularly pointed out in the written description and claims hereof, as well as from the appended drawings.

The standoff and pixel length calibration and resolution issues become less critical with the use of a linescan detector array employing optics in the form of a gradient-indexed lens array. With a gradient-indexed lens array, the field of view is a one-to-one relationship with the array due to unity magnification, and the focal distance is on the order of millimeters, not feet or even inches. This means that a very compact sensor can be designed to have the full functionality of a camera-style sensor with no setup calibrations required. Because the optics are linear, a gradient-indexed lens array can be made to fit any length of image sensor without suffering from lack of resolution or large object to lens distances.

In one aspect, the invention provides a device for detecting a web, the device including a light source adapted to emit light generally in the direction of the web; a lens spaced apart from the light source and adapted to receive light originating from the light source, the lens having a radial index of refraction gradient; and an image sensor aligned with the lens, the image sensor adapted to receive light from the lens and to convert the light to a signal.

In another aspect, the invention provides a method for detecting a web, the method including emitting light from a light source; capturing light reflected by the web with a lens having a radial index of refraction gradient; focusing the captured light on an image sensor; and converting the focused light to a signal.

In another aspect, the invention provides a method for aligning two webs, wherein each web has a position, the method including emitting light from a first light source; capturing light from the first light source reflected by the first web with a first lens having a radial index of refraction gradient; focusing the captured light from the first light source on a first image sensor; and converting the focused light from the first light source to a first signal. The method also includes emitting light from a second light source; capturing light from the second light source reflected by the second web with a second lens; focusing the captured light from the second light source on a second image sensor; converting the focused light from the second light source to a second signal; comparing the first signal with the second signal to determine if the webs are aligned; and adjusting the position of at least one of the webs until the webs are aligned.

In yet another aspect, the invention provides a method for detecting an object, the method including emitting light from a light source; capturing light reflected by the object with a lens having a radial index of refraction gradient; focusing the captured light on an image sensor; and converting the focused light to a signal.

Thus, the present invention, in its various aspects, advantageously relates to a web detection system that, when compared to conventional web detection systems, provides a highly accurate determination of the position or other qualities of a web or an object.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the containers of the invention. Together with the description, the drawings serve to explain the various aspects of the invention.

### BRIEF DESCRIPTION OF THE DRAWINGS

The present invention will be more fully understood and further advantages will become apparent when reference is made to the following detailed description of the invention and the accompanying drawings. The drawings are merely representative and are not intended to limit the scope of the claims. Like parts depicted in the drawings are referred to by the same reference numerals.

FIG. 1 representatively shows a schematic view of an example of a web detection system according to the present invention;

FIG. 2 representatively shows a schematic view of the paths followed by light through a conventional spherical lens;

FIG. 3 representatively shows a schematic view of the paths followed by light through a gradient-indexed lens used in the system of FIG. 1;

FIG. 4 representatively shows a perspective view of a gradient-indexed lens array, with two rows of lenses, used in the system of FIG. 1;

FIG. 5a representatively shows a perspective schematic view of the system of FIG. 1, including a web and objects on the web;

FIG. 5b representatively shows a schematic view of the component layout of the system of FIG. 1, as viewed in the cross-machine direction, or transverse to the direction of web travel; and

FIG. 6 representatively shows a graphical view of the cross correlation employed by the invention of FIG. 1.

### DETAILED DESCRIPTION OF THE INVENTION

The present invention is directed at solving problems related to the detection of qualities of a moving web of material. To actively control the alignment and manufacturing of a web and any objects thereon, certain qualities of the web and/or objects need to be detected. These qualities include the position of the edge of the web, defects in the moving web of material, positioning of one web relative to another, and the positioning, shape, alignment, doneness, or coverage of the web itself or of objects on the web. The invention described herein is applicable to any situation in which machine vision can be used, and is particularly adapted to be used when physical space limitations are such that other methods cannot be effectively used.

One example of the use of the method and apparatus will be presented in detail to illustrate the invention. Other applications of the method and apparatus will also be described.

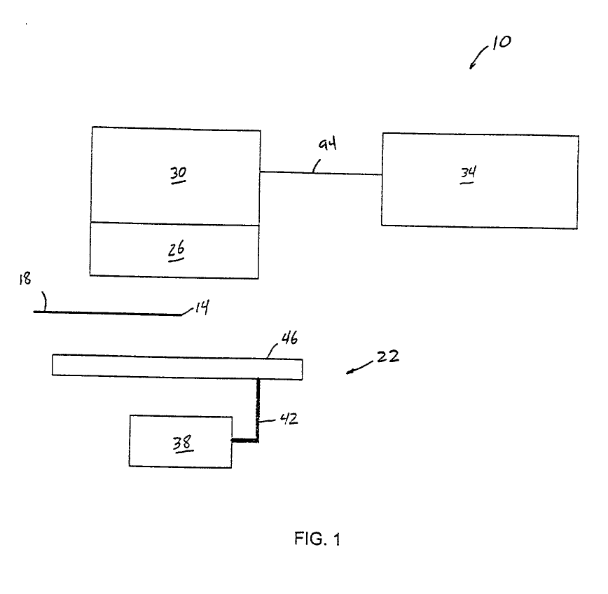

As an example, the present invention is directed at solving problems related to the detection of the edge of a moving web of material. As representatively illustrated in FIGS. 1-6, the present invention provides an apparatus and a method for detecting the edge of a moving web. Examples of specific equipment are described for illustrative purposes and are not intended to limit the invention. In addition, the apparatus and method is described herein using web edge detection as an example. The same apparatus and method may be used to detect defects in a web of material, or objects moving along a line, especially if the objects are positioned on a web.

The web detection system 10 of the present invention is used to detect the edge 14 of a web 18 and includes a light source 22, a lens array 26, an image sensor 30, and a signal processor 34. The signal generated by the web detection system 10 is transmitted to a web position adjuster (not shown) of a type as may be known to one skilled in the art, or to an operator or operating system.

The web detection system 10 includes a light source 22 for generating light to be used by the system 10. An illuminator 38 such as a SCHOTT-brand illuminator is connected through a fiber optic cable 42 to a fiber optic light line 46 such as a SCHOTT-brand fiber optic light line. Light generated by the illuminator 38 is transmitted through the fiber optic cable 42 to the fiber optic light line 46. The light line 46 is positioned adjacent the web 18.

In alternate embodiments, other light sources may be used, including fiber optic light lines using halogen bulbs, LED arrays, laser line generators, high-frequency fluorescent lighting systems, or any other suitable source of light. The light source 22 may also be ambient light. The light source 22 is preferably small and integrated into a sensing array package to permit easy mounting and alignment. A light regulator may also be used. The light from the light source 22 may be either coherent or incoherent, depending on the type of light source 22 used. As used herein, light refers to visible, infrared light, and ultraviolet light. In the case of ultraviolet light, the web 18 may include an optical brightener that fluoresces under ultraviolet light, thus converting the ultraviolet light to visible light.

The web detection system 10 also includes a lens array 26 for focusing light received from the light source 22. In the preferred embodiment, the lens array 26 is a gradient-indexed lens array.

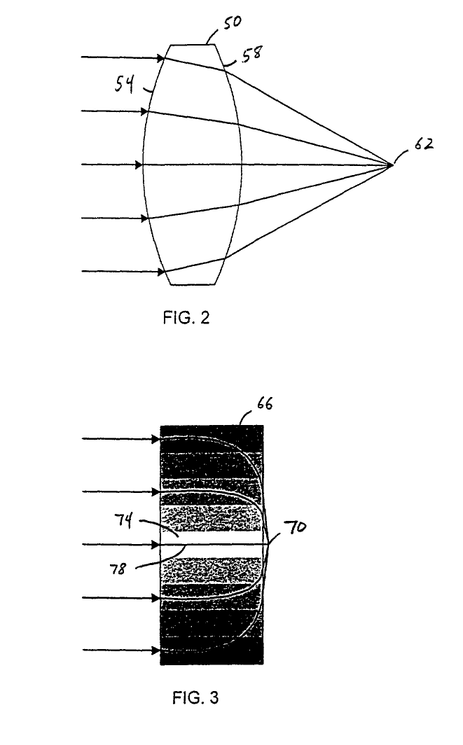

Gradient-indexed lenses differ from conventional spherical lenses in the manner in which they refract light. As illustrated in FIG. 2, a conventional spherical lens 50 can refract light only at its surfaces 54, 58, at the air-glass interface. By carefully controlling the shape, smoothness, and material properties of the lens 50, light can be focused at a given point 62.

A gradient-indexed lens 66, as illustrated in FIG. 3, is a lens 66 that has a radial index of refraction gradient. In other words, the index of refraction of the lens 66 is varied gradually within the lens material. Because light refracts continuously throughout the lens 66, the need for a tightly controlled lens shape is reduced, and the lens 66 can focus light on a point 70 much closer to the lens 66. The index of refraction is highest in the center 74 of the lens and decreases with radial distance from the axis 78 according to the following equation:

$$N ( r ) = {N}_{0} ( 1 - \frac{A}{2} {r}^{2} )$$

where N₀ is the index of refraction at the lens axis 78, A is a gradient constant, and r is the radius from the lens axis 78. The parabolic index profile allows the lens 66 to focus light in a shorter distance than a conventional spherical lens 50, which can only refract light at its surfaces 54, 58.

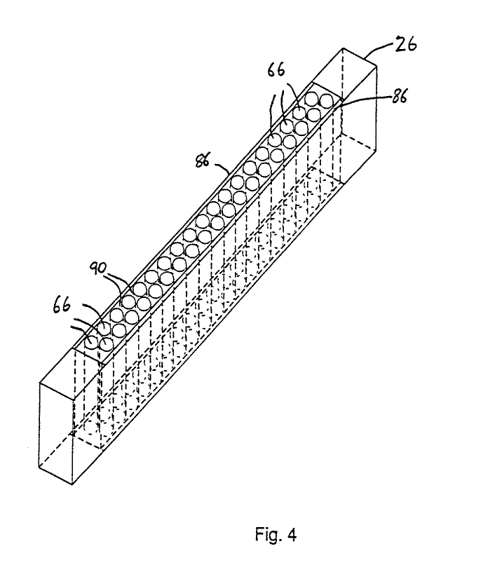

The spatial gradient of the index of refraction property of the gradient-indexed lens 66 lends itself very well to many applications because of the flexibility in its packaging. One-dimensional and two-dimensional lens arrays (see FIG. 4) are made in which images from adjacent lenses overlap and form a continuous erect image.

An example of a gradient-indexed lens array 26 is shown in FIG. 4. The lenses 66 in this gradient-indexed lens array 26 are precisely aligned between reinforced plates 86. The interstices 90 are filled with material to prevent crosstalk between the lenses 66 as well as to protect the individual lenses 66. The gradient-indexed lens array 26 described herein is a SELFOC-brand gradient-indexed lens array, Model No. SLA20B1466602A4, made by NSG America, Inc., although any suitable gradient-indexed lens array may be used. A lens array configuration is not limited to one or two rows of gradient-indexed lenses 66. As such, smaller or larger arrays of gradient-indexed lenses 66 may be used depending on the application. For example, a larger array of lenses 66 is typically known as a gradient-indexed lens plate and would be useful for detecting defects in a web 18 of material using the same apparatus and method described herein.

The web detection system 10 also includes an image sensor 30. The image sensor 30 is positioned adjacent the lens array 26 to receive light focused by the lens array 26. The image sensor 30 converts the light received from the lens array 26 into an electrical signal. The image sensor 30 may be a charge-coupled device (CCD) sensor, a complementary metal-oxide semiconductor (CMOS) sensor, or any other suitable sensor. The image sensor 30 described herein is a TEXAS INSTRUMENTS-brand CMOS image sensor, Model No. TSL218, although any compatible image sensor may be used. The image sensor 30 and the gradient-indexed lens array 26 are sized to accommodate the span of the edge location deviation.

The image sensor 30 comprises an array of light-receiving pixels. The image sensor 30 receives light generally within the wavelengths of 565-700 nm and converts it into an electric charge. Light energy incident on the pixels creates electron-hole pairs in the semiconductor region. The field generated by the bias on the pixels causes the electrons to collect in the pixels with the holes getting swept into the substrate. The amount of charge accumulated in each element is directly proportional to the amount of incident light and to the integration time. The array described herein comprises 512 elements with a center to center distance of 125 μm.

The web detection system 10 also includes a signal processor 34 electrically connected to the image sensor 30 to receive electrical signals from the image sensor 30, and to convert those electrical signals into a resultant signal indicating the edge 14 of the web 18. The signal processor 34 described herein includes a TEXAS INSTRUMENTS-brand digital signal processor, Model No. TMS320C542, although any compatible signal processor may be used. The signal processor 34 may also be included in the image sensor 30. The signal processor 34 may be implemented using hardware, software, firmware, or a combination thereof, as may be known to one skilled in the art.

The signal processor 34 provides the resultant signal indicating the edge 14 of the web 18 to a conventional web adjuster that adjusts the lateral position of the web 18 if necessary based on the signal from the signal processor 34. In the case of a web defect detector, the signal processor 34 sends a signal to an operator or operating system indicating a web defect.

In an alternate embodiment, web width measurements may be obtained by mounting two different systems 10 to a fixed bar, or by any other method suitable for fixing the distance between the systems 10. Knowing the length of the bar or the fixed distance between the systems 10, the signal processor 34 could allow for an output proportional to web width. The second system 10 could use the same or a different signal processor 34.

In another alternate embodiment, web width measurements may be obtained by using a system 10 of sufficient dimension to extend to both edges of the web. By determining the positions of both edges of the web, the signal processor 34 could allow for an output proportional to web width.

In operation of the web detection system 10, light generated by the illuminator 38 is passed through the fiber optic cable 42 to the fiber optic light line 46. The light is then transmitted from the fiber optic light line 46 toward the web 18 and in the vicinity of the gradient-indexed lens array 26. The web 18 itself blocks some of the light transmission, and some light is reflected by the web 18 and impinges upon the gradient-indexed lens array 26.

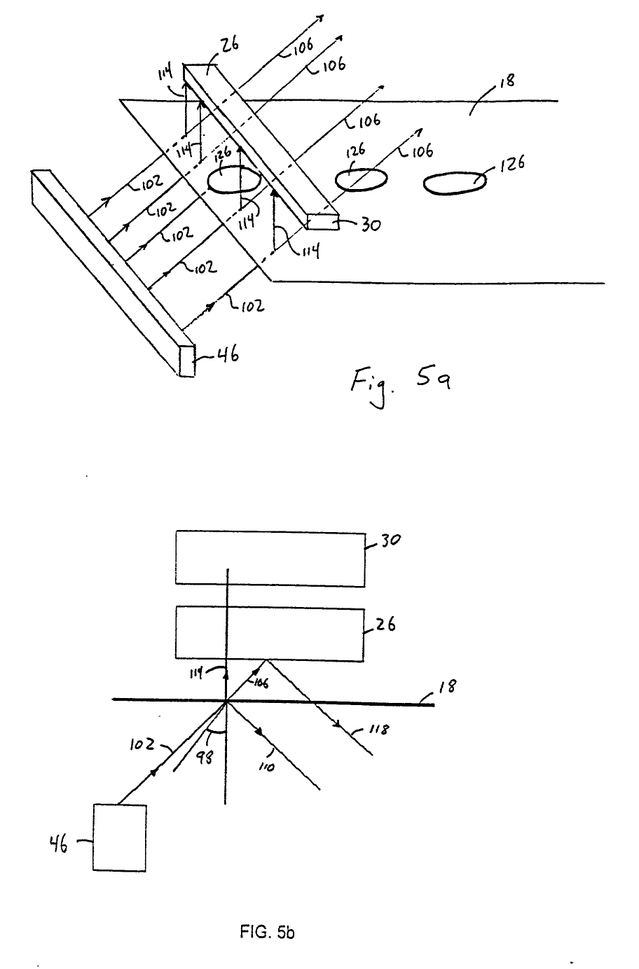

For the image sensor 30 to obtain a high-resolution image, the lighting should be configured in such a way as to provide a sharp contrast. FIG. 5 shows one configuration that may be used for a nonwoven or other non-opaque web 18. FIG. 5a shows the configuration looking in the machine direction, or the direction of web travel, and FIG. 5b shows the configuration looking in the cross-machine direction, or transverse to the direction of web travel. The distance from the light line 46 to the web 18 is not a critical distance.

In the configuration shown in FIG. 5, the fiber optic light line 46 illuminates the web 18 at an angle such that the image sensor 30 will only see light reflected by the web 18. Because the gradient-indexed lens array 26 has a maximum viewing angle or acceptance angle 98 of 20°, and because the light line 46 is positioned to provide light at an angle greater than 20°, any light that passes directly from the light line 46 to the lens array 26 will reflect off the face of the lens array 26. Because only light within the 20° acceptance angle 98 of the lens array 26 will pass through the lens array 26, only light from the fiber optic light line 46 that is reflected by the web 18 to within that acceptance angle 98 will pass through the lens array 26. As such, the lens array 26, and thus the image sensor 30, will only see fiber optic light line light that has been reflected by the web 18, or, more specifically, by fibers within the web 18. The acceptance angle 98 of the lens array 26 example described herein is 20°, but lens arrays with other acceptance angles are also available, and one skilled in the art will select the proper lens array for a given application.

More specifically, and as an example, FIG. 5b illustrates the acceptance angle property of the gradient-indexed lens array 26. Arrow 102 in FIG. 5b represents a plane of light exiting the fiber optic light line 46. When this light reaches the web 18, the light has either been transmitted through the web 18 without reflecting off the web fibers (see arrow 106), reflected off the web 18 entirely (see arrow 110), or reflected off the fibers of the web 18 and into the gradient-indexed lens array 26 (see arrow 114). Because light from the light line 46 was directed at the web 18 at an angle greater than the gradient-indexed lens array acceptance angle of 20°, all of the light represented by arrow 106 reflects off of the gradient-indexed lens array 26 (see arrow 118). This is a highly desirable result because as seen from FIG. 5a, only the light scattered by the web's fibers passes through the gradient-indexed lens array 26. This allows for a clear transition for the image sensor 30 between light, where the web 18 is present, and dark where no web 18 is present.

In an alternative embodiment (not shown), the light line 46 may be positioned on the same side of the web 18 as the lens array 26. Such arrangement works similarly to the arrangement shown in FIG. 5. Light that passes through or past the web 18 without being reflected continues onward without impacting the lens array 26. Light that is reflected by the web 18 to the lens array 26 and within the gradient-indexed lens array acceptance angle 98 of 20° passes through the lens array 26 to the image sensor 30. The specific arrangement of light line 46 and lens array 26 for a given application is determined primarily by the space available in which to install the system 10, and by the material properties of the web 18.

Light that passes through the gradient-indexed lens array 26 is focused by the gradient-indexed lens array 26 on the image sensor 30, which then generates electrical signals based on which pixels in the image sensor 30 receive light and with what intensity the pixels receive the light. The image sensor 30 then sends these electrical signals to the signal processor 34 over a line 94. Alternately, incorporating the image sensor 30 and the signal processor 34 in the same component would eliminate the need for line 94.

The signal processor 34 receives the electrical signals and calculates the position of the web 18 using those electrical signals in a cross correlation calculation. The signal processor 34 then transmits the position of the web 18 to the web adjuster that acts to adjust the lateral position of the web 18 if necessary. In the case of a web defect detection system, the signal processor 34 receives the electrical signals and determines the existence of a web defect using those electrical signals in a cross correlation calculation. The signal processor 34 then transmits the signal to an operator or operating system indicating the web defect.

Cross correlation such as that used by the signal processor 34 is a mathematical operation that is very common in signal and image processing. It allows for the comparison of two different signals or images, the result of which is a function that characterizes how similar the signals or images are. The cross correlation is given in its continuous time domain and spatial domain form by the following equations:

$${R}_{fh} ( t ) = {\int }_{- ∞}^{∞} f ( τ ) h ( τ - t ) ⅆ τ \qquad {R}_{fh} ( x ) = {\int }_{- ∞}^{∞} f ( τ ) h ( τ - x ) ⅆ τ$$

where f and h are continuous functions of time and spatial displacement.

There are many uses for cross correlation in signal and image processing. It offers a filtering property so that signal noise can be isolated from the known parts of temporal signals or spatial images. It offers the ability to find the temporal or spatial location of a particular signal or image within a more complex signal or image. It inherently has the ability to produce a high-resolution temporal or spatial location estimate of a signal or image. In the system 10 described herein, cross correlation calculations are performed to obtain sub-pixel resolution to diminish the effect of spatial opacity variations, to create a higher range to resolution ratio, and to allow the use of sensor output as input to a state observer.

The determination of the raw edge of the web 18 is done with a simple thresholding technique in which the threshold is set to one half of the full-scale level.

Once the pixel representing this threshold is found, it is possible to employ a cross correlation algorithm while maintaining the processing speed necessary for control application.

Although a one-millimeter resolution is sufficient in a typical web guiding application, more resolution would allow increased utility by enabling the sensor to be used in state feedback observers. Observers are limited by the quantization of the signals. To reduce the quantization effects seen when difference operations are used to find state estimates, resolution needs to be increased.

Cross correlation can be performed in the continuous or in the discrete time domain where it can be implemented in digital signal processors (DSPs). Although other microprocessors can implement the routine, DSPs (and ASICs based on similar technology) have the advantage of being able to do the multiply and accumulate functions necessary for the calculations in much less time than other microprocessors due to the inherent DSP architecture.

As an example, two signals are cross-correlated to obtain greater resolution of the present image (most current real-time image): the reference signal (ideal edge measured previously) and the present image. The reference image differences function was obtained experimentally with a homogeneous 201b, white stationery paper edge by taking the difference of nine successive pixels. Using this information, the difference function was fitted to a sixth-order polynomial yielding a continuous function. This continuous function was then evaluated at 0.05 pixel increments to allow for a 0.05-pixel resolution (6.25 μm) in the cross-correlation function.

The peak of the cross-correlation calculations using eight pixels of information with a 0.05-pixel resolution represents the web edge location. To calculate this function using image difference functions with an increased 0.02-pixel resolution, it would take approximately 37 ms for a 40 MHz DSP, which would make it too slow to be used for web guide control. Conversely, a similar function derived from only one pixel of information and at a 0.02-pixel resolution takes slightly less than 6 ms and can be performed while staying over the bandwidth limitation of 100 Hz. This function fully agrees with the function obtained using all eight pixels; therefore, the cross-correlation calculation with one pixel of information can be used to predict the location of the web edge. Because the goal is finding the peak of the function, using more data points does not provide any more useful information about the edge location and can therefore be excluded from calculations.

This reduction in the necessary number of data points allows the cross-correlation calculations to be performed within the signal processor 34, rather than in additional hardware interfaced with the signal processor 34. As a result, the hardware design is streamlined without the addition of complicated circuitry. Performing such calculations in firmware rather than hardware improves the efficiency of the process.

Performing cross-correlation calculations in such a manner also allows for a more effective treatment of a potentially complicating factor. Spatial opacity variations caused by nonhomogeneous, translucent materials can cause the web edge location to vary more than one pixel as is indicated by a change in the peak of the cross-correlation functions, where one pixel equals 125 μm. In some machine direction web samples, the cross-correlation peak provides a more accurate indication of web edge location than simply using the location of the raw edge based on simple thresholding. This indicates that not only does the cross-correlation function allow for increased image resolution, it also serves to provide a more accurate indicator of where the edge is located.

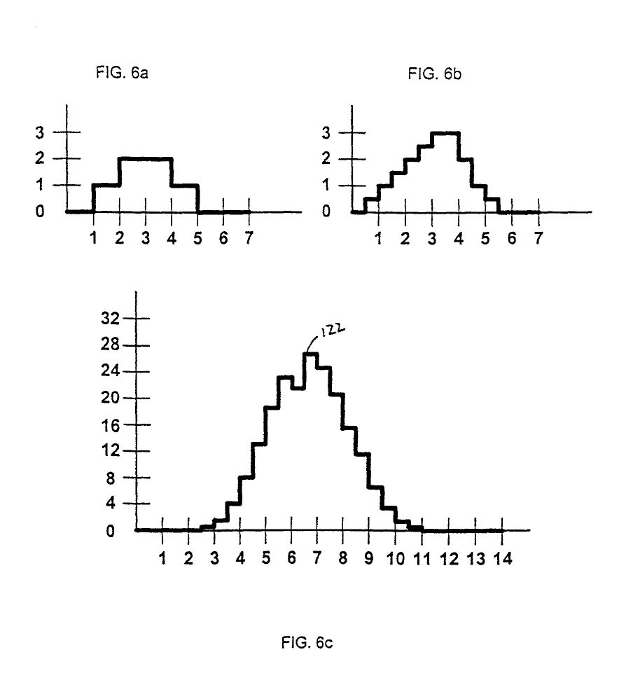

An example of the cross correlation operation as applied to web edge detection is shown in FIG. 6. This example uses discrete functions of linear displacement f (see FIG. 6a) and h (see FIG. 6b). The plot in FIG. 6a represents a simplified difference function of a discretized image. The function comprises seven unique points. FIG. 6b represents a reference function, obtained separately in a controlled fashion, for the discretized image and, in this example, has twice as many points as the discretized image over the same spatial distance. When cross-correlated, the cross correlation function that is generated, FIG. 6c, has the same resolution as the function with the highest resolution—the reference function. This changes the range to resolution ratio as the range (the total linear displacement) stays the same while the resolution increases. The increased resolution allows the sensor output to function as a state feedback observer input, as resolution reduces quantization errors associated with observer implementations. Lastly, the calculation diminishes the effect of spatial opacity variations or noise. As illustrated in FIG. 6c, even though the discretized image of FIG. 6a does not show a clear edge, the image cross-correlated with the reference function does show an edge. The cross correlation function (see FIG. 6c) shows a peak 122 at x=6.5. This is the point at which the functions show the most correlation or overlap, which consequently corresponds to the web edge 14. This makes the cross correlation algorithm a much more powerful edge detection algorithm than simple thresholding alone.

Because the specification for the resolution over the displacement range of a suitable array is finer than most arrays, a cross correlation algorithm needs to be employed to obtain sub-pixel resolution while also filtering out spatial noise associated with opacity variations. At the same time, the one-to-one ratio of object to image provided by such a system 10 means that no scaling and thus no calibration needs to be performed. As such, the flexibility in sizing of the lens array 26 and the image sensor 30 allows flexible scaling of the field of view without calibration procedures.

Accordingly, the different aspects of the present invention can advantageously provide a web detection system 10 that, when compared to conventional systems, provides improved accuracy in the detection of a web edge 14 or other properties or objects of or on the web.

The resolution of the web detection system 10 described herein allows for a finer control of web guides or width control mechanisms than is currently realized with conventional edge sensors. Web guide control requires position-sensing bandwidths greater than 100 Hz to permit global stability over the operating range of a web guide. Both the short web-to-sensor distance and the compact sensor design allow for the deployment of sensors in confined areas on machines. The flexibility in sensor sizing and frequency optimization allows the system 10 to be used in a wide variety of applications. A relatively simple design using low cost components further increases the flexibility and applicability of the system 10.

Similarly, the method and apparatus described above can be applied to virtually any situation requiring machine vision. One skilled in the art can choose the dimensions of the lens and array and the light source needed for any given application.

In an alternative embodiment illustrated in FIG. 5a, the same functionality of the web edge system 10 that discerns between different web materials, thicknesses, densities, etc. can be used to detect objects 126, including objects positioned on a web. As in the embodiments described above, light 102 from a light source 46 is directed at the web 18. Light 114 that is reflected by or within the web 18 is directed to the lens 26 and image sensor 30. Unreflected light 106 passes the lens 26. Some of the light 102, although it may be reflected by or within the web 18, is blocked by an object 126 and thus does not impinge on the lens 26. The web detection system 10 can thus discern the web 18 and the object 126. By the methods described herein, the shape, position, reflectivity, or other quality of the object 126 may be determined. That information can then be sent to a controller that, for example, can adjust the position of the object 126, reject the object 126 if the object 126 is of insufficient quality, control the operation of a sprayer or other action, or any other suitable action.

As an example, a web of spunbond material may be overlaid with discrete absorbent pads. The method and apparatus described herein can be adapted to indicate to the operator where a given pad begins and ends, and/or whether the pad is correctly aligned. This knowledge may be used to simply confirm the positioning of the absorbent pad, or to control, for example, an adhesive spray such that it only sprays on the absorbent pad. Because the absorbent pad will likely have a different thickness, density, or material from the web, the apparatus can easily determine its position. Just as the web edge detection determines the web edge by difference in light performance between where the web is and where the web is not, the apparatus can also determine the difference in light performance between two different thicknesses/densities/materials of the web, or the difference between the web and an object on the web.

Likewise, based on the capability of the apparatus to detect differences in and between materials and objects, the apparatus can be used in many applications. Uses for the method and apparatus include, but are not limited to, measurement of gaps in or between materials, film edge control, in glass manufacturing, to determine web widths, to determine shaft diameters, in missing parts detection, in the manufacture and use of tapes, including tapes used in the manufacture and transportation of semiconductors, in the manufacture and use of video and audio tapes, as a slot sensor, and to determine the position, presence, absence, shape, doneness, coverage, etc. of objects on any type of conveyor system.

As an illustration of the latter example, the method and apparatus described herein can be used in cookie production. Portions of cookie dough are placed on a conveyor, which then travels through an oven including baking elements located in close proximity to the conveyor, leaving little room for a detection system. Because of the small space requirements of the apparatus described herein, a detection system may be positioned within the oven section. Providing sufficient contrast in light reflectivity or color between the conveyor and the cookie dough allows the detection system to “see” the cookies as they travel through the oven section. The detection system can be used to determine a quality of each cookie. For example, the detection system can determine whether each cookie has sufficient roundness, the position of each cookie, and/or the doneness of each cookie. Cookies of insufficient quality can be rejected.

In alternate embodiments, other types of radiation may be used in the place of light in the method and apparatus described herein, including microwaves, x-rays, gamma, beta, and neutron radiation, provided suitable lens and sensing devices are used.

While the invention has been described in detail with respect to the specific aspects thereof, it will be appreciated that those skilled in the art, upon attaining an understanding of the foregoing, may readily conceive of alterations to, variations of, and equivalents to these aspects. Accordingly, the scope of the present invention should be assessed as that of the appended claims and any equivalents thereto.

What is claimed is:

1. A device for detecting a web, the device comprising:
a light source adapted to emit light generally in the direction of the web;
a lens spaced apart from the light source and adapted to receive light originating from the light source, the lens having a radial index of refraction gradient; and
an image sensor aligned with the lens, the image sensor adapted to receive light from the lens and to convert the light to a signal.

2. The device of claim 1, wherein the light source, the lens, and the image sensor are positioned adjacent to an edge of the web such that the device is capable of detecting the edge of the web.

3. The device of claim 2, wherein the web has an actual position and a desired position, and wherein the device determines the actual position of the web edge, and wherein the device is adapted to transmit the actual position to a position controller.

4. The device of claim 3, wherein the position controller is adapted to adjust the position of the web based on the actual and desired positions of the web.

5. The device of claim 1, further comprising a signal processor coupled to the image sensor, the processor receiving the signal, wherein the web has an edge with a position, and wherein the signal processor uses a cross correlation to process the signal to determine the edge position with sub-pixel resolution.

6. The device of claim 1, wherein the light source, the lens, and the image sensor are positioned away from an edge of the web such that the device is capable of detecting a defect in the web.

7. The device of claim 1, wherein the light source, the lens, and the image sensor are positioned away from an edge of the web such that the device is capable of detecting an object on the web.

8. The device of claim 7, wherein the device is capable of detecting the shape of an object on the web.

9. The device of claim 7, wherein the device is capable of detecting the position of an object on the web.

10. The device of claim 7, wherein the device is capable of detecting the quality of an object on the web.

11. The device of claim 1, wherein the lens is a gradient-indexed lens array.

12. The device of claim 1, wherein the lens is a two-dimensional gradient-indexed lens array.

13. The device of claim 1, wherein the image sensor is a CMOS image sensor.

14. The device of claim 1, wherein the image sensor is a CCD image sensor.

15. The device of claim 1, further comprising a signal processor coupled to the image sensor, the processor receiving the signal.

16. The device of claim 15, wherein the web has a lateral position, and wherein the signal processor uses a cross correlation to process the signal to determine the lateral position with sub-pixel resolution.

17. The device of claim 1, wherein the lens is positioned on the opposite side of the web from the light source.

18. The device of claim 1, wherein the lens is positioned on the same side of the web as the light source.

19. The device of claim 1, wherein the light is visible light.

20. The device of claim 1, wherein the light is infrared.

21. The device of claim 1, wherein the light is ultraviolet.

22. The device of claim 1, wherein the light is ambient light.

23. The device of claim 1, wherein the light source emits incoherent light.

24. The device of claim 1, wherein the light source emits coherent light.

25. The device of claim 1, wherein the light received by the lens has been reflected by the web.

26. The device of claim 1, wherein the web includes fibers, and wherein the light received by the lens has been reflected by the fibers.

27. The device of claim 1, wherein the lens has at least one focus point, and wherein the image sensor is positioned substantially at the focus point.

28. The device of claim 1, wherein the lens has an acceptance angle, and wherein the light source is positioned to emit light at an angle to the lens greater than the acceptance angle.

29. A device for detecting the position of an edge of a web, the device comprising:
a light source adapted to emit light generally in the direction of the web, wherein a portion of the light is reflected by the web;
an image sensor adapted to receive the portion of light and to convert the portion to a signal; and
a signal processor adapted to process the signal using a cross correlation to determine the edge position web with sub-pixel resolution.

30. The device of claim 29, further comprising a lens spaced apart from the light source and adapted to receive the portion of the light reflected by the web, the lens having a radial index of refraction gradient.

31. The device of claim 30, wherein the lens is a gradient-indexed lens array.

32. The device of claim 30, wherein the lens is a two-dimensional gradient-indexed lens array.

33. The device of claim 29, wherein the device is positioned adjacent to an edge of the web such that the device is capable of detecting the edge of the web.

34. The device of claim 29, wherein the light source, the lens, and the image sensor are positioned away from an edge of the web such that the device is capable of detecting a defect in the web.

35. The device of claim 29, wherein the light source, the lens, and the image sensor are positioned away from an edge of the web such that the device is capable of detecting an object on the web.

36. A method for detecting a web, the method comprising:
emitting light from a light source;
capturing light reflected by the web with a lens having a radial index of refraction gradient;
focusing the captured light on an image sensor; and
converting the focused light to a signal.

37. The method of claim 36, further comprising transmitting the signal to a web position controller.

38. The method of claim 36, further comprising converting the signal to a form usable by a person monitoring the web.

39. The method of claim 36, further comprising converting the signal to a form usable by a system monitoring the web.

40. The method of claim 36, further comprising detecting an edge of the web, wherein the light source, the lens, and the image sensor are positioned adjacent to the edge of the web.

41. The method of claim 36, further comprising processing the signal using a signal processor.

42. The method of claim 41, wherein the web has an actual position and a desired position, wherein the signal processor determines the actual position of the web, and wherein the signal processor transmits the actual position to a position controller.

43. The device of claim 42, wherein the position controller adjusts the position of the web based on the actual and desired positions of the web.

44. The device of claim 36, wherein a signal processor coupled to the image sensor receives the signal, wherein the web has a position, and wherein the signal processor uses a cross correlation to process the signal to determine the position with sub-pixel resolution.

45. The device of claim 36, further comprising detecting a defect in the web, wherein the light source, the lens, and the image sensor are positioned away from an edge of the web.

46. The device of claim 36, further comprising detecting an object on the web, wherein the light source, the lens, and the image sensor are positioned away from an edge of the web.

47. The device of claim 46, wherein the detecting act includes detecting a shape of an object on the web.

48. The device of claim 46, wherein the detecting act includes detecting a position of an object on the web.

49. The device of claim 46, wherein the detecting act includes detecting a quality of an object on the web.

50. The device of claim 36, wherein the lens is a gradient-indexed lens array.

51. The device of claim 36, wherein the lens is a two-dimensional gradient-indexed lens array.

52. The device of claim 36, wherein the image sensor is a CMOS image sensor.

53. The device of claim 36, wherein the image sensor is a CCD image sensor.

54. The device of claim 36, further comprising positioning the lens on the opposite side of the web from the light source.

55. The device of claim 36, further comprising positioning the lens on the same side of the web as the light source.

56. The device of claim 36, further comprising positioning the light source to emit light at an angle to the lens greater than an acceptance angle of the lens.

57. A method for aligning two webs, wherein each web has a position, the method comprising:
emitting light from a first light source;
capturing light from the first light source reflected by the first web with a first lens having a radial index of refraction gradient;
focusing the captured light from the first light source on a first image sensor;
converting the focused light from the first light source to a first signal;
emitting light from a second light source;
capturing light from the second light source reflected by the second web with a second lens;
focusing the captured light from the second light source on a second image sensor;
converting the focused light from the second light source to a second signal;
comparing the first signal with the second signal to determine if the webs are aligned; and
adjusting the position of at least one of the webs until the webs are aligned.

58. The method of claim 57, wherein the first light source and the second light source are the same light source.

59. The method of claim 57, wherein the second lens has a radial index of refraction gradient.

60. The method of claim 57, wherein the adjusting act includes adjusting at least one of the webs such that the webs are aligned in a machine-direction.

61. The method of claim 57, wherein the adjusting act includes adjusting at least one of the webs such that the webs are aligned in a cross-machine-direction.

62. A method for detecting an object, comprising:
emitting light from a light source;
capturing light reflected by the object with a lens having a radial index of refraction gradient;
focusing the captured light on an image sensor; and
converting the focused light to a signal.

63. The method of claim 62, further comprising converting the signal to a form usable by a person monitoring the object.

64. The method of claim 62, further comprising converting the signal to a form usable by a system monitoring the object.

65 The method of claim 62, further comprising processing the signal using a signal processor.

66. The method of claim 65, wherein the object has an actual quality and a desired quality, wherein the signal processor determines the actual quality of the object, and wherein the signal processor transmits the actual quality to a controller.

67. The method of claim 66, wherein the controller adjusts a process based on the actual and desired qualities of the object.

68. The method of claim 65, wherein the processing act includes determining a shape of the object.

69. The method of claim 65, wherein the processing act includes determining a position of the object.

70. The method of claim 65, wherein the lens is a gradient-indexed lens array.

71. The method of claim 65, wherein the lens is a two-dimensional gradient-indexed lens array.

72. The method of claim 65, wherein the image sensor is a CMOS image sensor.

73. The method of claim 65, wherein the image sensor is a CCD image sensor.

74. The method of claim 65, further comprising positioning the lens on the opposite side of the web from the light source.

75. The method of claim 65, further comprising positioning the lens on the same side of the web as the light source.

76. The method of claim 65, further comprising positioning the light source to emit light at an angle to the lens greater than an acceptance angle of the lens.

77. The method of claim 65, further comprising capturing light reflected by a web, wherein the object is positioned on a web.

78. The method of claim 65, wherein the object is a component of an absorbent article.

79. The method of claim 65, wherein the object is a foodstuff.

80. The method of claim 65, wherein the object is a manufactured object.

81. A web detection system comprising:
a light source adapted to emit light generally in the direction of the web;
a means for focusing light reflected by the web using a radial index of refraction gradient; and
an image sensor adapted to receive focused light and to convert the focused light to a signal.

82. The system of claim 81, wherein the means is a lens.

83. The system of claim 81, wherein the means is a gradient-indexed lens array.

84. The system of claim 81, wherein the means is a two-dimensional gradient-indexed lens array.

85. A device for aligning two webs, wherein each web has a position, the device comprising:
a first light source adapted to emit light generally in the direction of the first web;
a first lens spaced apart from the first light source and adapted to receive light originating from the first light source, the first lens having a radial index of refraction gradient;
a first image sensor aligned with the first lens, the first image sensor adapted to receive light from the first lens and to convert the light to a first signal;
a first signal processor coupled to the first image sensor, the first signal processor receiving the first signal;
a second light source adapted to emit light generally in the direction of the second web;
a second lens spaced apart from the second light source and adapted to receive light originating from the second light source;
a second image sensor aligned with the second lens, the second image sensor adapted to receive light from the second lens and to convert the light to a second signal; and
a second signal processor coupled to the second image sensor, the second signal processor receiving the second signal.

86. The device of claim 85, wherein the first light source and the second light source are the same light source.

87. The device of claim 85, wherein the first signal processor and the second signal processor are the same signal processor.

88. The device of claim 85, wherein the second lens has a radial index of refraction gradient.

89. The device of claim 85, further comprising a first position controller adapted to adjust the position of the first web based on a signal from the first signal processor.

90. The device of claim 89, further comprising a second position controller adapted to adjust the position of the second web based on a signal from the second signal processor.

91. The device of claim 90, wherein the first position controller and the second position controller are the same position controller.

92. The device of claim 85, further comprising a position controller adapted to adjust the position of at least one of the webs such that the webs are aligned.

93. The device of claim 92, wherein the position controller is adapted to align the webs in a machine-direction.

94. The device of claim 92, wherein the position controller is adapted to align the webs in a cross-machine direction.

95. A device for detecting an edge of a web, the device comprising:
a light source adapted to emit light generally in the direction of the web;
a lens spaced apart from the light source and adapted to receive light that originates from the light source and is reflected by the web, the lens being an array of lenses each having a radial index of a refraction gradient, wherein the lens has at least one focus point and an acceptance angle, and wherein the light source is positioned to emit light at an angle to the lens greater than the acceptance angle;
an image sensor aligned with the lens and positioned substantially at the focus point, the image sensor being a CMOS image sensor adapted to receive light from the lens and convert the light to a signal; and
a signal processor coupled to the image sensor, wherein the signal processor receives the signal, and wherein the signal processor uses a cross correlation to process the signal to determine the edge with sub-pixel resolution.
